(19) United States
(12) Patent Application Publication
(10) Pub. No.: US 2008/0183531 A1
(43) Pub. Date: Jul. 31, 2008

(54) Method and System for Balancing Asset Liability and Supply Flexibility in Extended Value Networks

(76) Inventors: Markus Ettl, Yorktown Heights, NY (US); Yingdong Lu, Yorktown Heights, NY (US); Mark S. Squillante, Pound Ridge, NY (US)

Correspondence Address: Whitham, Curtis & Christofferson, PC., Suite 340, 11491 Sunset Hills Road, Reston, VA, 20190, US

(21) Appl. No.: 12/061,071

(22) Filed: Apr. 2, 2008

Related U.S. Application Data
(63) Continuation of application No. 11/207,763, filed on Aug. 22, 2005.

(51) Int. Cl. G06Q 10/00

(52) U.S. Cl. 705/7

(57) ABSTRACT

The present invention provides a method, a system, and a computer-readable medium with instructions for a computer to optimize one or more tradeoffs between or among serviceability, liability, and/or inventory in a multi-tier network of suppliers. The probabilistic optimization of tradeoffs enables assets stored at one or a plurality of tiers in the network to be optimally transferred downstream with certain probabilities. The multi-tier network of suppliers may consist of at least one original equipment manufacturer tier and at least one supplier tier.

### BACKGROUND OF THE INVENTION

1. Field of the Invention

The present invention generally relates to supply chain management and, more particularly, to management of a horizontally aggregated network of suppliers in a supply chain employing an outsourcing model.

2. Background Description

In an effort to remain competitive and balance low pricing with fast innovation, many original equipment manufacturers (OEMs) have outsourced parts of their manufacturing and business operations to service partners such as contract manufacturers, electronics manufacturing service providers, and outsourced design manufacturers. The trend towards outsourcing has significant implications for OEM supply chains. In the absence of outsourcing, an OEM would manage a vertically integrated supply chain in which a single entity designs, builds, tests, sells and delivers products to its customers. With outsourcing, however, OEMs must manage a horizontally aggregated network of suppliers, sometimes referred to as value chain partners or value network partners.

Notwithstanding these benefits, however, many firms that have moved from a vertically integrated supply chain to an outsourcing arrangement have found that managing a loosely coupled and diverse network of value chain partners presents drawbacks that do not present themselves in the context of a vertically integrated supply chain, including, but not limited to:
Higher cost from reduced visibility and control of suppliers that do not interact directly with the OEM;
Higher financial risks as a result of uncertainty attributable to difficulties in measuring and monitoring the performance of suppliers;
Greater risk of liability for excess inventory compared to a vertically integrated supply chain, due to the distribution of inventory among suppliers at various nodes of a horizontally aggregated network of suppliers; and
Increased latency compared to a vertically integrated supply chain, due to cascaded information flows from one tier of a horizontally aggregated network of suppliers to another.
   The present invention recognizes problems arising when an outsourcing model is used instead of a vertically integrated supply chain and also provides a solution to such problems.

### SUMMARY OF THE INVENTION

It is an object of the present invention to provide a method, a system, and instructions on a computer-readable medium for using a computer to balance asset liability and supply flexibility in extended value networks (i.e., horizontally aggregated network of suppliers in a supply chain employing an outsourcing model).

The present invention employs computer hardware and software systems and methods for managing (optimizing and controlling) trade-offs between inventory liability and supply flexibility with or without knowledge of any lower-tier value network partner policy. Where the value network consists of at least one retailer or manufacturer (e.g. OEM) and one supplier (e.g. contract manufacturer, service provider, distributor, material supplier, and so forth). Where the relationship between a retailer or manufacturer and a supplier can be realized as vendor-managed inventory (VMI), line-side stocking, or other arrangements. Where the trade-off could be based on minimizing liability exposure, lost sales penalties or SLA violations. Computer hardware and software systems and methods may be employed according to the present invention to determine an optimal operational policy that balances the tradeoffs among serviceability, liability or inventory. Computer hardware and software systems and methods may also be employed for monitoring and proactive alerting to adjust inventory relative to business objectives comprised of serviceability, liability or inventory.

The present invention models tradeoffs between asset liability and supplier flexibility using optimization methods and probabilistic methods (which includes deterministic methods as a special case). First, a method, a system, and instructions on a computer-readable medium are provided for using a computer to manage (i.e., to optimize and/or control) the tradeoff between asset liability and supply flexibility with or without knowledge of any value network partner policy. In addition, a method, a system, and instructions on a computer-readable medium are provided for using a computer to determine an optimal operational policy balancing the tradeoffs between or among serviceability, liability and/or inventory that can be enforced in contractual supplier agreements. Finally, a method, a system, and instructions on a computer-readable medium are provided for using a computer to monitor and proactively provide alerts to adjust supplier-managed assets relative to business objectives comprised of serviceability, liability or inventory. The present invention's method, system, and instructions on a computer-readable medium may be applied to multiple industries in which outsourcing is utilized, including but not limited to electronics, manufacturing, automotive, retail, packaged consumer goods, and workforce planning.

To ensure high levels of service to end customers, original equipment manufacturers (OEMs) desire high flexibility from their value network partners. This tends to increase supply chain assets, inventory and procurement costs. Increasing supply chain assets tends to increase an OEM's liability exposure and financial risk. The present invention uses optimization and probabilistic methods to model tradeoffs between or among serviceability, liability, and/or inventory in order to manage the increased asset liability and supply flexibility which tend to result from increases in the level of service to end customers.

Take as an example an OEM that wants to share its component purchasing leverage with its contract manufacturer to ensure that supply is purchased at the lowest total cost. The OEM might pay for raw materials supply from a certain components supplier but never take physical possession of the inventory, and have it shipped to its contract manufacturer directly. The financial settlement occurs between the supplier and the OEM, but the raw materials supply is shipped from the supplier to the contract manufacturer, and the contract manufacturer delivers the final product directly to the OEM's customers. The cascaded supply chain process presents a challenge to demand and supply synchronization since contract manufacturers do not have visibility into the true demand for final products they are fulfilling for the OEM's customers. Since the contract manufacturers operate based on forecasts that are often unreliable, they may incur premiums in expediting inventory to service unforeseen orders or dealing with excess inventory and their related costs. The costs for either shortages or excess inventory incurred in the upstream supply network create an aggregate liability for the OEM.

While every industry struggles with instabilities in demand and supply synchronization, industries with short product lifecycles or where raw materials being sourced off-shore with long lead times have the greatest exposure to asset liability and write-offs. Inventory build-ups across the supply network impose a great financial risk as demand begins to taper off before a recognizable downward trend emerges or a market downturn coincides with a product's end of life. It puts OEMs at risk of announcing missed earnings or inventory write-offs at the end of a financial quarter, and causing decreased levels of confidence in the organization.

The present invention determines a risk-optimized operating region for purchased materials that helps OEMs and their service partners manage value chain assets with certain probabilities. It helps OEMs and their service partners to mitigate asset risk and work smarter in managing their supply lines. It helps supply partners implement supply flexibility programs that allow them to service spikes in demand while keeping the asset exposure (e.g., inventory) to a minimum. It also helps finding the right levels of assets needed for production through a demand-pull program such as vendor-managed inventory (VMI) or supplier-managed inventory (SMI).

This is accomplished by using financial and operational value chain data such as forecasts, forecast accuracy, procurement lead times, in-transit inventory to a supplier-managed inventory location, and supply and liability risk profiles. Since asset liability and supply flexibility usually depend on negotiated agreements between OEMs and their service partners, an operating policy may be enforced through contractual obligations requiring that supplier-managed assets to stay within specified optimal operating regions.

The present invention may be applied to any multi-tier network of value chain partners consisting of OEMs, service providers, contract manufacturers, component suppliers, distributors, etc. Such networks are said to be multi-tiered in the sense that material stored (or produced and then stored) by a firm at one tier is provided to a firm at another tier as in input for use in a manufacturing process (or to be held in inventory for future use as such an input). A firm receiving an input is said to be downstream from the firm providing the input. Examples include, without limitation, manufacturing-assembly (in which a subassembly supplier is upstream from a manufacturer of the finished product) and workforce supply networks (in which skilled workers may be provided under contract as inputs to a service business).

In such multi-tier networks of value chain partners, assets may be stored and/or assembled at each tier and then shipped to the next downstream tier. At each time t, the system status of each tier is determined by the on-hand asset inventory I(t), a vector of pipeline asset inventory Q(t), a demand forecast D(t). Given these factors, a replenishment action can be taken. The replenishment decision then will become part of the pipeline inventory for every time period (t+1, t+2 . . . , T+L), where L is the upstream lead time.

The overall performance of the extended value network is measured by serviceability and liability metrics. Serviceability metrics can include fill rate, backorders, and customer waiting time. Asset liabilities (in particular inventory liabilities) are determined from the demand forecast created by a downstream tier such as an OEM, the actual material consumption by the downstream tier, and a liability window. In most applications, an upstream tier cannot apply full control over a downstream tier because no centralized control policy exists for the entire system. In these cases, a replenishment action cannot be explicitly determined from the current conditions and forecasts.

The present invention proposes that the on-hand asset inventory I(t) is maintained within a certain operating region. To ensure that overall performance metrics are met, the invention identifies a region for performance metrics sequences, such that overall performance can be guaranteed if the performance metrics sequence falls within the region with certain probabilities. Meanwhile, other aspects of performance (e.g., profitability, revenue) can be optimized subject to the condition that performance metric sequences operate within the determined region. Alternatively, a utility function can be defined and minimized.

The present invention provides a method, a system, and instructions on a computer-readable medium for managing supplier networks, whereby:
Assets are stored at one or a plurality of tiers in a multi-tier network of suppliers;
A computer is used to determine an optimization and control of one or a plurality of tradeoffs involving serviceability, liability, and inventory in said multi-tier network of suppliers using
   a serviceability metric A(t,I(t),Q(t)) and
   a liability metric B(t,I(t),Q(t))
where, at each time t, t=1, 2, . . . , T. I(t) represents on-hand asset inventory to be maintained within a risk-optimized operating region and Q(t) represents a vector of pipeline asset inventory.
A computer generates a signal that product stored at one tier in said multi-tier network of suppliers should be transferred to a next downstream tier. The means used for generating such a signal in a system according to the present invention may be a computer or other data processing or signal processing apparatus.

The present invention also provides that:
The multi-tier network of suppliers may consist of at least one retailer tier and at least one supplier tier.
The step of using a computer to determine balances said tradeoffs among serviceability, liability, and inventory.
The signal for product stored at one tier to be transferred to a next downstream tier may initiate an automatic transfer of product and/or may notify a human operator of a need to transfer product.
   The present invention further provides an alert to adjust inventory relative to business objectives comprised of at least one of serviceability, liability, and inventory. The means used for providing such an alert in a system according to the present invention may be a computer or other data processing or signal processing apparatus.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a representation of a multi-tier network of suppliers managed according to the present invention.

FIG. 2 is a representation of a multi-tier network of suppliers, as in FIG. 1, being managed by a computer programmed with instructions from a computer-readable medium according to the present invention.

FIG. 3 is a representation of a risk-optimized operating region determined according to the optimization and probabilistic methods of the present invention.

FIG. 4 is a representation of a risk-optimized operating region according to the present invention.

### DETAILED DESCRIPTION OF A PREFERRED EMBODIMENT OF THE INVENTION

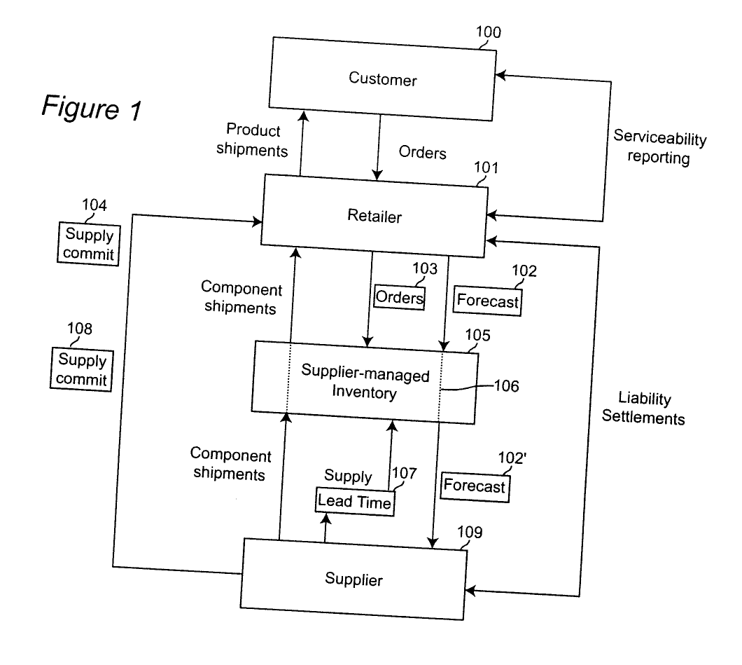

Referring now to the drawings, and more particularly to FIG. 1, there is shown a multi-tier network of suppliers managed according to the present invention. Four tiers are shown in FIG. 1: a customer 100, a retailer 101, (in this case an OEM), a supplier-managed inventory 105, and a supplier 109. The customer 100 interacts with the retailer 101 through product shipments, orders, and serviceability reporting. Inputs move in a downstream direction from the supplier 109 to the supplier-managed inventory 105 to the retailer 101.

The retailer 101 provides a forecast 102 to the supplier-managed inventory 105, which passes the forecast 102′ through to the supplier 109, as shown by a dotted line 106. The supplier 109 provides a supply commit 108 to supply the supplier-managed inventory 105, taking into account a certain lead time 107, based on the forecast 102, 102′ from the retailer 101. A supply commit 104 is made by supplier-managed inventory 105 to the retailer 101 based on orders 103. Product supplied to the supplier-managed inventory 105 is thus held until called for by an order 103, at which time a supply commit 104 is made to retailer 101 so that the order may be filled. The supplier 109 is thus able to meet commitments to the retailer 101, within the accuracy of the forecast 102, 102′. Liability settlements are made between the retailer 101 and the supplier 109.

At the retailer 101 tier, the availability of product for the end customer can be more readily determined because inventory is exposed throughout the supply chain. At the supplier-managed inventory 105 tier, supply flexibility is enhanced. Finally at the supplier 109 tier, the ability to meet supply commitments 104, 108 is enhanced because of improvements in the accuracy of forecasts 102, 102′.

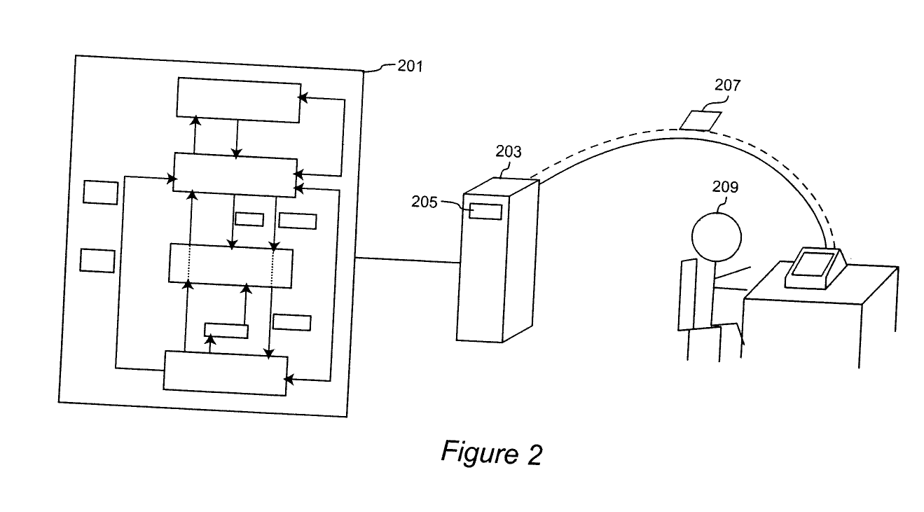

Referring now to FIG. 2, there is shown a multi-tier network of suppliers 201, as in FIG. 1, being managed by a computer 203 which has been programmed with instructions from a computer-readable medium 205 according to the present invention. The computer 203 generates a signal that product stored at one tier in the multi-tier network of suppliers 201 should be transferred to a next downstream tier. The signal causes an email 207 to be sent to notify a human operator 209 of the need to transfer product.

To illustrate the optimization and probabilistic methods of our invention, take as an example, without limitation, the following generic supply chain with serviceability/liability goals. Suppose that inventory replenishment decisions have to be made at each time t=1,2, . . . , T, to meet random demands D₁,D₂, . . . D_{T}. To simplify the description of the model, we assume that the Dᵢ's are independent and follow the normal distribution N(μᵢ, σᵢ), although our invention is not restricted to this assumption. Similarly, assume the supplier lead time is a constant L.

As noted above, the supplier and retailer cannot be controlled in a centralized manner. The contract between the supplier and the retailer requires the retailer to provide a set of numbers for the appropriate region of the inventory level for the supplier together with the probabilities associated with this region. For example, without limitation, the region can be specified by a lower bound LB and an upper bound UB of the inventory level that the supplier should keep on-hand, together with a percentage of time that the actual on-hand asset inventory is between the lower and upper bound, e.g. 90% of the time the inventory should be above 100,000, but below 250,000. If the supplier operates within this region, it will not be responsible for inventory liabilities and the retailer's serviceability. However, if the inventory level falls outside the region, then the supplier will be responsible for inventory liabilities and/or the retailer's serviceability.

Let us denote by I(t) the inventory at each time t, and by IP the reorder point, i.e. at each time t, the supplier will order to enforce its inventory position (inventory plus pipeline) to the level of

$$IP = {\sum }_{i \leq L} {μ}_{t + i} + k \sqrt{{\sum }_{i \leq L} {σ}_{t + i}^{2}} .$$

Recall that μₜ₊ᵢ and σₜ₊ᵢ are the mean and variance of the random demands D_{t+I} at time t+i. At each time t, the actual serviceability is defined by

$$f ( t ) = P [ {\sum }_{i = 0}^{L - 1} {D}_{t - i} \leq IP ]$$

which is a function of the reorder point IP.
Therefore, under the above assumptions, the overall serviceability over the planning horizon T is

$$\begin{matrix}\frac{1}{T} {\sum }_{t = 1}^{T} f ( t ) = \frac{1}{T} {\sum }_{t = 1}^{T} P [ {\sum }_{i = 0}^{L - 1} {D}_{t - i} \leq IP ] \\ = \frac{1}{T} {\sum }_{t = 1}^{T} [ 1 - Φ ( \frac{IP - {\sum }_{i = 0}^{L - 1} {μ}_{t - i}}{\sqrt{{\sum }_{i = 0}^{L - 1} {σ}_{t - i}^{2}}} ) ] .\end{matrix}$$

If the target serviceability is α, then we can determine the optimal reorder point IP that satisfies

$$\frac{1}{T} {\sum }_{t = 1}^{T} P [ {\sum }_{i = 0}^{L - 1} {D}_{t - i} \leq IP ] = α .$$

Under this policy, the mean (M) and standard deviation (Σ) of the on-hand inventory are given by

$$\begin{matrix}M = \frac{1}{T} {\sum }_{t = 1}^{T} {E [ IP - {\sum }_{i = 0}^{L - 1} {D}_{t - i} ]}^{+} \\ = \frac{1}{T} {\sum }_{t = 1}^{T} [ ( \frac{IP - {\sum }_{i = 0}^{L - 1} {μ}_{t - i}}{\sqrt{{\sum }_{i = 0}^{L - 1} {σ}_{t - i}^{2}}} ) \overline{Φ} ( \frac{IP - {\sum }_{i = 0}^{L - 1} {μ}_{t - i}}{\sqrt{{\sum }_{i = 0}^{L - 1} {σ}_{t - i}^{2}}} ) - φ ( \frac{IP - {\sum }_{i = 0}^{L - 1} {μ}_{t - i}}{\sqrt{{\sum }_{i = 0}^{L - 1} {σ}_{t - i}^{2}}} ) ] ,\end{matrix}$$

$$and$$

$$\begin{matrix}Σ = \frac{1}{T} \sqrt{{\sum }_{t = 1}^{T} {\text{Var} [ IP - {\sum }_{i = 0}^{L - 1} {D}_{t - i} ]}^{+}} \\ = \frac{1}{T} \sqrt{{\sum }_{t = 1}^{T} [ \begin{matrix}\begin{matrix}( {( \frac{IP - {\sum }_{i = 0}^{L - 1} {μ}_{t - i}}{\sqrt{{\sum }_{i = 0}^{L - 1} {σ}_{t - i}^{2}}} )}^{2} - 1 ) \overline{Φ} ( \frac{IP - {\sum }_{i = 0}^{L - 1} {μ}_{t - i}}{\sqrt{{\sum }_{i = 0}^{L - 1} {σ}_{t - i}^{2}}} ) - \\ ( \frac{IP - {\sum }_{i = 0}^{L - 1} {μ}_{t - i}}{\sqrt{{\sum }_{i = 0}^{L - 1} {σ}_{t - i}^{2}}} ) φ ( \frac{IP - {\sum }_{i = 0}^{L - 1} {μ}_{t - i}}{\sqrt{{\sum }_{i = 0}^{L - 1} {σ}_{t - i}^{2}}} ) -\end{matrix} \\ {[ ( \frac{IP - {\sum }_{i = 0}^{L - 1} {μ}_{t - i}}{\sqrt{{\sum }_{i = 0}^{L - 1} {σ}_{t - i}^{2}}} ) \overline{Φ} ( \frac{IP - {\sum }_{i = 0}^{L - 1} {μ}_{t - i}}{\sqrt{{\sum }_{i = 0}^{L - 1} {σ}_{t - i}^{2}}} ) - φ ( \frac{IP - {\sum }_{i = 0}^{L - 1} {μ}_{t - i}}{\sqrt{{\sum }_{i = 0}^{L - 1} {σ}_{t - i}^{2}}} ) ]}^{2}\end{matrix} ]}\end{matrix}$$

Therefore, we can determine the α-lower bound of the on-hand inventory LB from the following expression as a function of the safety factor k:

LB=M−kΣ,

where the safety factor k satisfies the following requirement on the target serviceability α:

P[N(0,1)>k]=α.

Asset liabilities often depend on a negotiated settlement between an upstream and a downstream value chain tier. Although the details of the settlement may differ from contract to contract, liabilities are generally determined by the demand forecast created by the downstream tier, the actual material consumption, and a liability window as follows. Table 1 shows an example, without limitation, of a rolling forecast for a 13-week planning period (e.g., a quarter) with weekly forecast updates. The length of the cancellation window is four weeks. Each row in the table indicates a forecast update. Future forecasts within the liability window are color-coded in white. Future forecasts outside of the liability window are color-coded yellow. Actual demand is color-coded brown.

TABLE 1
Forecast scenario with 4-week cancellation window.

| | Forecast (13-week outlook) | | | | | | | | | | | | |
|---|---|---|---|---|---|---|---|---|---|---|---|---|---|
| Week | 1 | 2 | 3 | 4 | 5 | 6 | 7 | 8 | 9 | 10 | 11 | 12 | 13 |
| 1 | 2,500 | 2,500 | 2,500 | 2,500 | 2,500 | 2,500 | 2,500 | 2,500 | 2,500 | 2,500 | 2,500 | 2,500 | 2,500 |
| 2 | 600 | 2,000 | 2,000 | 2,000 | 2,000 | 2,000 | 2,000 | 2,000 | 2,000 | 2,000 | 2,000 | 2,000 | 2,000 |
| 3 | 600 | 500 | 1,000 | 1,000 | 1,000 | 1,000 | 1,000 | 1,000 | 1,000 | 1,000 | 1,000 | 1,000 | 1,000 |
| 4 | 600 | 500 | 400 | 1,000 | 1,000 | 1,000 | 1,000 | 1,000 | 1,000 | 1,000 | 1,000 | 1,000 | 1,000 |
| 5 | 600 | 500 | 400 | 300 | 1,000 | 1,000 | 1,000 | 1,000 | 1,000 | 1,000 | 1,000 | 1,000 | 1,000 |
| 6 | 600 | 500 | 400 | 300 | 300 | 800 | 800 | 800 | 800 | 800 | 800 | 800 | 800 |
| 7 | 600 | 500 | 400 | 300 | 300 | 500 | 800 | 800 | 800 | 800 | 800 | 800 | 800 |
| 8 | 600 | 500 | 400 | 300 | 300 | 500 | 100 | 600 | 600 | 600 | 600 | 600 | 600 |
| 9 | 600 | 500 | 400 | 300 | 300 | 500 | 100 | 800 | 600 | 600 | 300 | 300 | 300 |

For example, the future forecast at the beginning of week 7 indicates that 800 units were projected each week from week 7 until week 13. The actual demand in the first six weeks of the quarter was 2,600 units. The running liability is the actual demand since the beginning of the quarter, plus the forecasted volume inside the liability window, or 5,800 units.

To determine asset liabilities, the method tracks the running liability and a so-called high-water mark. The high-water mark is updated only if the running liability in a future week exceeds the current high-water mark. The idea is that actual demand is applied against the high-water mark, and the difference between the two measures is the current liability. To predict the liability that a downstream tier could accumulate until the end of a quarter, the remaining forecasted volumes through quarter-end are subtracted from the current liability. For example, the current liability at the beginning of week 7 is 7,400 units and the remaining forecast for weeks 7 to 13 is 5,600 units which results in a predicted quarter-end liability, Y, of 1,800 units. Table 2 illustrates the computations of quarter-end liabilities based on the scenario shown in Table 1.

TABLE 2
Computation of quarter-end liabilities with high-water marks.

| | Running | | | | Predicted |
|---|---|---|---|---|---|
| | liability | High-water | Actuals | Current | quarter-end |
| Week | horizon | mark | to Date | liability | liability |
| 1 | 10,000 | 10,000 | — | 10,000 | — |
| 2 | 8,600 | 10,000 | 600 | 9,400 | — |
| 3 | 5,100 | 10,000 | 1,100 | 8,900 | — |
| 4 | 5,500 | 10,000 | 1,500 | 8,500 | — |
| 5 | 5,800 | 10,000 | 1,800 | 8,200 | — |
| 6 | 5,300 | 10,000 | 2,100 | 7,900 | 1,500 |
| 7 | 5,800 | 10,000 | 2,600 | 7,400 | 1,800 |
| 8 | 5,100 | 10,000 | 2,700 | 7,300 | 3,700 |
| 9 | 5,300 | 10,000 | 3,500 | 6,500 | 4,400 |

Another crucial part of the liability is the end-of-quarter (EOQ) inventory, since the total liability is determined by both predicted quarter-end liability and this EOQ inventory. For example, in many practical instances, the total liability is the maximum of the liability calculated above and the EOQ inventory. From the illustrative example of our inventory algorithm above, we can see that the EOQ inventory is a random variable, namely

$${[ IP - {\sum }_{i = 0}^{L - 1} {D}_{T - i} ]}^{+} ,$$

and hence its mean and variation can be estimated. In particular, we have

$$\begin{matrix}{M}_{T} = {E [ IP - {\sum }_{i = 0}^{L - 1} {D}_{T - i} ]}^{+} \\ = [ ( \frac{IP - {\sum }_{i = 0}^{L - 1} {μ}_{T - i}}{\sqrt{{\sum }_{i = 0}^{L - 1} {σ}_{T - i}^{2}}} ) \overline{Φ} ( \frac{IP - {\sum }_{i = 0}^{L - 1} {μ}_{T - i}}{\sqrt{{\sum }_{i = 0}^{L - 1} {σ}_{T - i}^{2}}} ) - φ ( \frac{IP - {\sum }_{i = 0}^{L - 1} {μ}_{T - i}}{\sqrt{{\sum }_{i = 0}^{L - 1} {σ}_{T - i}^{2}}} ) ]\end{matrix}$$

$$\begin{matrix}{Σ}_{T} = \sqrt{{\text{Var} [ IP - {\sum }_{i = 0}^{L - 1} {D}_{t - i} ]}^{+}} \\ = \sqrt{[ \begin{matrix}( {( \frac{IP - {\sum }_{i = 0}^{L - 1} {μ}_{T - i}}{\sqrt{{\sum }_{i = 0}^{L - 1} {σ}_{T - i}^{2}}} )}^{2} - 1 ) \overline{Φ} ( \frac{IP - {\sum }_{i = 0}^{L - 1} {μ}_{T - i}}{\sqrt{{\sum }_{i = 0}^{L - 1} {σ}_{T - i}^{2}}} ) - \\ ( \frac{IP - {\sum }_{i = 0}^{L - 1} {μ}_{T - i}}{\sqrt{{\sum }_{i = 0}^{L - 1} {σ}_{T - i}^{2}}} ) φ ( \frac{IP - {\sum }_{i = 0}^{L - 1} {μ}_{T - i}}{\sqrt{{\sum }_{i = 0}^{L - 1} {σ}_{T - i}^{2}}} ) - \\ {[ ( \frac{IP - {\sum }_{i = 0}^{L - 1} {μ}_{T - i}}{\sqrt{{\sum }_{i = 0}^{L - 1} {σ}_{T - i}^{2}}} ) \overline{Φ} ( \frac{IP - {\sum }_{i = 0}^{L - 1} {μ}_{T - i}}{\sqrt{{\sum }_{i = 0}^{L - 1} {σ}_{T - i}^{2}}} ) - φ ( \frac{IP - {\sum }_{i = 0}^{L - 1} {μ}_{T - i}}{\sqrt{{\sum }_{i = 0}^{L - 1} {σ}_{T - i}^{2}}} ) ]}^{2}\end{matrix} ]} .\end{matrix}$$

Therefore the expected total asset liability is

$$E [ max \{ N ( {M}_{T} , {Σ}_{T} ) , Y \} = ( Y - {M}_{T} ) \overline{Φ} ( \frac{Y - {M}_{T}}{{Σ}_{T}} ) - {Σ}_{T} φ ( \frac{Y - {M}_{T}}{{Σ}_{T}} ) + {M}_{T} ,$$

where Y is the predicted quarter-end liability.
If the total liability is required to be less than a certain target γ for at least β% of the time, then we should set the upper bound for the inventory to be

$$UB = {max}_{i} \{ {M}_{i} + max ( \frac{γ - {M}_{T}}{{Σ}_{T}} , \frac{β}{100} ) {Σ}_{i} \} .$$

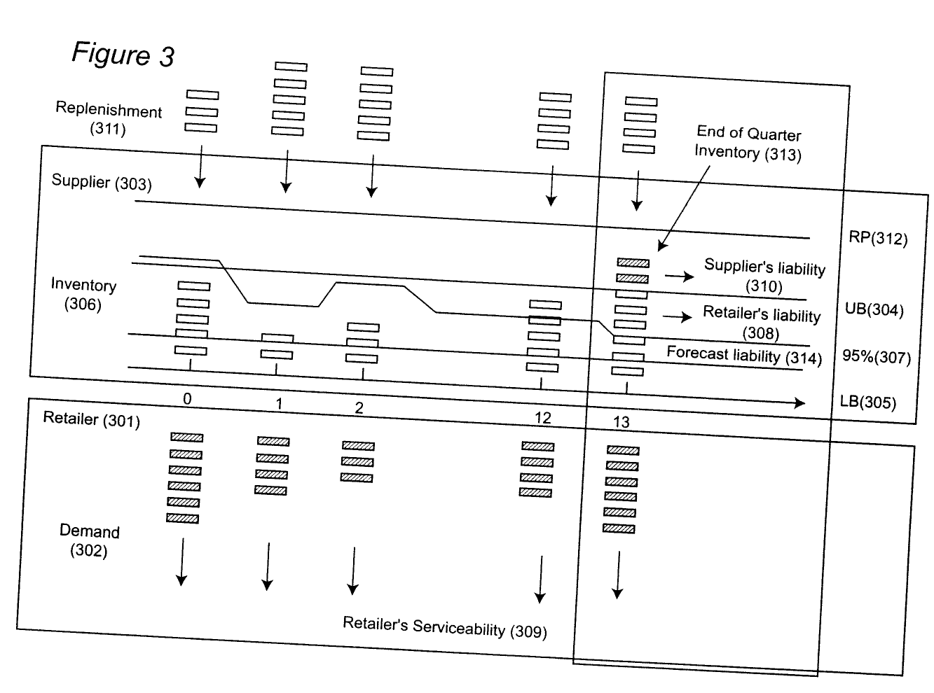

Referring now to FIG. 3, there is shown a representation of a risk-optimized operating region determined according to the optimization and probabilistic methods of the present invention. In particular, the retailer 301 provides the demands D₁, . . . , D₁₃ in 302. The supplier 303 provides the replenishment 311 with lead time L. As part of the contract between the supplier 303 and the retailer 301, the retailer 301 provides an upper bound 304 and lower bound 305 to specify the region of inventory level 306 together with the probabilities 307 associated with this region.

As long as the supplier 303 maintains the inventory level 306 between the upper bound 304 and the lower bound 305, the supplier 303 will not be responsible for the retailer's liability 308 and retailer's serviceability 309. However, if the inventory level 306 exceeds the upper bound 304, then the supplier 303 is responsible for the supplier's liability 310. On the other hand, if the inventory level 306 falls below the lower bound 305, then the supplier 303 is responsible for the retailer's serviceability 309.

Whenever the inventory 306 plus the pipeline inventory in replenishment 311 falls below the reorder point 312, the supplier 303 will place a replenishment order to enforce its inventory position to the level of the reorder point 312. The serviceability 309 and the reorder point 312 are both computed as described above. The mean and standard deviation of the inventory 306 are then computed as described above, from which we obtain the β-lower bound probability 307.

The end-of-quarter (EOQ) inventory 313 is computed as described above. Then the expected total liability is computed from the predicted quarter-end liability 314 and the EOQ inventory 313, also as described above. Finally, the upper bound 304 and lower bound 305 for the inventory is obtained as described in the example above.

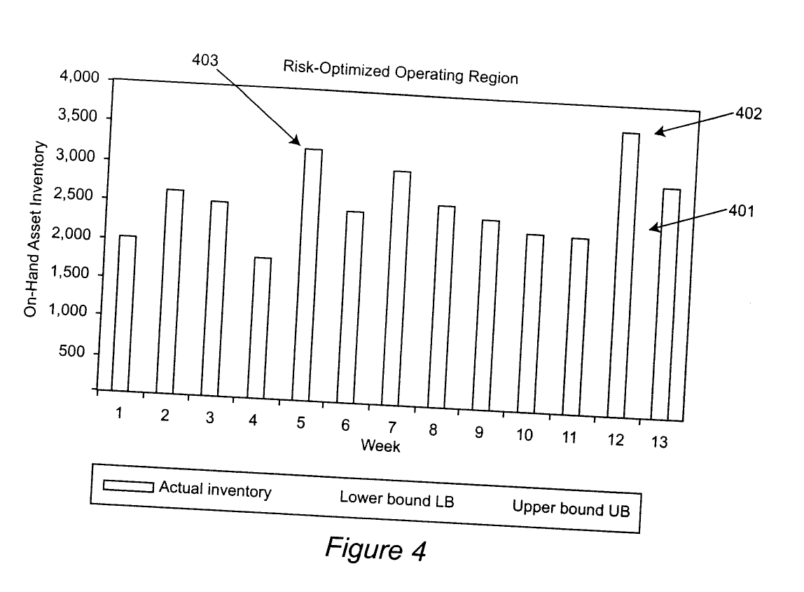

FIG. 4 shows a specific instance of a risk-optimized operating region according to the present invention for the forecast scenario provided in Table 1 above. The lower bound LB 401 and upper bound UB 402 in the figure are determined by the present invention for target serviceability α=95%, and target liability γ=and β=95%. The bars 403 represent the actual on-hand asset inventory that the supplier holds in each time period. The individual bars that exceed the LB 401 and UB 402 lines represent those random events that fall within the confidence limits of the target serviceability α and the liability tolerance β.

While the invention has been described in terms of a set of preferred embodiments, those skilled in the art will recognize that the invention can be practiced with modification within the spirit and scope of the appended claims.

Having thus described our invention, what we claim as new and desire to secure by Letters Patent is as follows:

1. A method for managing supplier networks, comprising the steps of:
storing assets at one or a plurality of tiers in a multi-tier network of suppliers;
using a computer to determine an optimization and control of one or a plurality of tradeoffs involving serviceability, liability, and inventory in said network using a serviceability metric A(t,I(t),Q(t)) and a liability metric B(t,I(t),Q(t)), where, at each time t, t=1, 2, . . . , T.
I(t) represents on-hand asset inventory to be maintained within a risk-optimized operating region, and
Q(t) represents a vector of pipeline asset inventory; and
using a computer to generate a signal that product stored at one tier in said multi-tier network of suppliers should be transferred to a next downstream tier.

2. The method of claim 1 wherein said multi-tier network of suppliers consists of at least one retailer tier and at least one supplier tier.

3. The method of claim 1 wherein said using a computer to determine step balances said tradeoffs among serviceability, liability, and inventory.

4. The method of claim 1 wherein said signal initiates an automatic transfer of product.

5. The method of claim 1 wherein said signal notifies a human operator of a need to transfer product.

6. The method of claim 1 further comprising the step of providing an alert to adjust inventory relative to business objectives comprised of at least one of serviceability, liability, and inventory.

7. A system for managing supplier networks, comprising:
a computer optimizing and controlling one or a plurality of tradeoffs involving serviceability, liability, and inventory in a multi-tier network of suppliers using a serviceability metric A(t,I(t),Q(t)) and a liability metric B(t,I(t),Q(t)), where, at each time t, t=1, 2, . . . , T,
I(t) represents on-hand asset inventory to be maintained within a risk-optimized operating region, and
Q(t) represents a vector of pipeline asset inventory; and
a means for generating a signal that product stored at one tier in a multi-tier network of suppliers should be transferred from one tier to a next downstream tier.

8. The system of claim 7, wherein said multi-tier network of suppliers consists of at least one original equipment manufacturer tier and at least one supplier tier.

9. The system of claim 7 wherein said computer balances said tradeoffs among serviceability, liability, and inventory.

10. The system of claim 7 wherein said signal initiates an automatic transfer of product.

11. The system of claim 7 wherein said signal notifies a human operator of a need to transfer product.

12. The system of claim 7 further comprising a means for providing an alert to adjust inventory relative to business objectives comprised of at least one of serviceability, liability, and inventory.

13. A computer-readable medium for managing supplier networks, on which is provided:
instructions for a computer to optimize and control one or a plurality of tradeoffs between serviceability, liability, inventory in a multi-tier network of suppliers using a serviceability metric A(t,I(t),Q(t)) and a liability metric B(t,I(t),Q(t)), where, at each time t, t=1, 2, . . . , T,
I(t) represents on-hand asset inventory to be maintained within a risk-optimized operating region, and
Q(t) represents a vector of pipeline asset inventory; and
instructions for a computer to generate a signal that product stored at one tier in a multi-tier network of suppliers should be transferred to a next downstream tier.

14. The computer-readable medium of claim 13 wherein said multi-tier network of suppliers consists of at least one original equipment manufacturer tier and at least one supplier tier.

15. The computer-readable medium of claim 13 wherein said instructions for a computer to optimize and control one or a plurality of tradeoffs balance said tradeoffs among serviceability, liability, and inventory.

16. The computer-readable medium of claim 13 wherein said signal initiates an automatic transfer of product.

17. The computer-readable medium of claim 13 wherein said signal notifies a human operator of a need to transfer product.

18. The computer-readable medium of claim 13 on which is further provided instructions for using a computer to provide an alert to adjust inventory relative to business objectives comprised of at least one of serviceability, liability, and inventory.
